(19) United States
(12) Patent Application Publication
(10) Pub. No.: US 2023/0258763 A1
(43) Pub. Date: Aug. 17, 2023

(54) RADIO FREQUENCY SENSING TO DETECT WIRELESS DEVICES AND USER PRESENCE BY AN AUTONOMOUS VEHICLE

(71) Applicant: GM Cruise Holdings LLC, San Francisco, CA (US)

(72) Inventor: Burkay Donderici, Burlingame, CA (US)

(21) Appl. No.: 17/669,630

(22) Filed: Feb. 11, 2022

(51) Int. Cl. G01S 5/02; B60W 60/00

(52) U.S. Cl. CPC G01S 5/0278; B60W 60/00253; B60W 2556/45

(57) ABSTRACT

Disclosed are systems and techniques for managing an autonomous vehicle. In some aspects, an autonomous vehicle may obtain one or more radio frequency (RF) signals corresponding to a wireless device. In some cases, the autonomous vehicle may determine a location probability map associated with the wireless device based on the one or more RF signals. In some examples, the autonomous vehicle may adjust a behavior of the autonomous vehicle based on the location probability map associated with the wireless device.

### FIELD OF THE DISCLOSURE

Aspects of the present disclosure generally relate to autonomous vehicles. In some implementations, examples are described for performing radio frequency (RF) sensing to detect wireless devices and user presence by an autonomous vehicle.

### BACKGROUND

An autonomous vehicle is a motorized vehicle that can navigate without a human driver. An example autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

Autonomous vehicles can be implemented by companies to provide self-driving car services for the public, such as taxi or ride-hailing (e.g., ride-sharing) services. The self-driving car services can increase transportation options and provide a flexible and convenient way to transport users between locations. A user will typically request a ride through an application provided by the self-driving car service to use a self-driving car service. When requesting the ride, the user can designate a pick-up and drop-off location, which the self-driving car service can use to identify the route of the user and select a nearby autonomous vehicle that is available to provide the requested ride to the user. In some cases, an autonomous vehicle may implement one or more machine learning algorithms for perceiving the environment, predicting the future trajectory of objects in the environment, and/or operating the autonomous vehicle.

### BRIEF DESCRIPTION OF THE DRAWINGS

FIG. 1 illustrates an example of a system for managing one or more Autonomous Vehicles (AVs), in accordance with some aspects of the present technology.

FIG. 2 illustrates an example of an environment for performing radio frequency sensing by an autonomous vehicle, in accordance with some aspects of the present technology.

FIG. 3 illustrates examples of a method for performing radio frequency sensing by an autonomous vehicle, in accordance with some aspects of the present technology.

FIG. 4 illustrates another example of a method for performing radio frequency sensing by an autonomous vehicle, in accordance with some aspects of the present technology.

FIG. 5 illustrates an example of a system for implementing certain aspects of the present technology.

### DETAILED DESCRIPTION

Certain aspects and embodiments of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects and embodiments described herein may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the application as set forth in the appended claims.

An autonomous vehicle can support different modes of operation with varying degrees of autonomy. In some cases, an autonomous vehicle may be configured to operate in a driverless autonomous driving mode in which the autonomous vehicle may operate without a driver or technician providing local human supervision. While operating in a driverless autonomous driving mode, an autonomous vehicle may utilize perception software (e.g., a perception stack) together with one or more sensors to detect and classify objects within its environment. In some cases, an autonomous vehicle can utilize prediction software (e.g., a prediction stack) to predict the future trajectory of objects in the environment (e.g., based on data received from the perception stack). In some examples, an autonomous vehicle can utilize planning software (e.g., a planning stack) to operate and/or maneuver the autonomous vehicle (e.g., based on data received from the prediction stack).

In some cases, an autonomous vehicle may encounter pedestrians or users that are carrying one or more wireless devices. In some examples, users of wireless devices can be distracted and therefore present a higher risk for unpredictable behavior that can increase the risk for accidents. In addition, the risk of accidents may be increased if the user of the wireless device is occluded or not perceived correctly by the autonomous vehicle.

The disclosed technologies address a need in the art for performing radio frequency (RF) sensing by an autonomous vehicle to assist in locating and identifying wireless devices and/or users of wireless devices. In some examples, an autonomous vehicle can receive RF signals that can be used to determine a direction and distance of a wireless device relative to the autonomous vehicle. In some examples, the direction and distance of the wireless device can be used to determine one or more probabilistic locations of the wireless device.

In some aspects, the probabilistic locations of the wireless devices can be used to generate one or more maps that can be used by the perception stack, the prediction stack, and/or the planning stack to adjust a behavior of the autonomous vehicle. For example, the perception stack can use wireless device location data to direct sensors to most likely occupancy areas. The perception stack can collect additional data from such areas and provide the data to the prediction stack. In some aspects, the prediction stack can use the perception data to adjust predicted behavior of users of wireless devices. In some examples, the planning stack can adjust the trajectory, speed, path, and/or any other operation of the autonomous vehicle based on the revised predictions from the prediction stack.

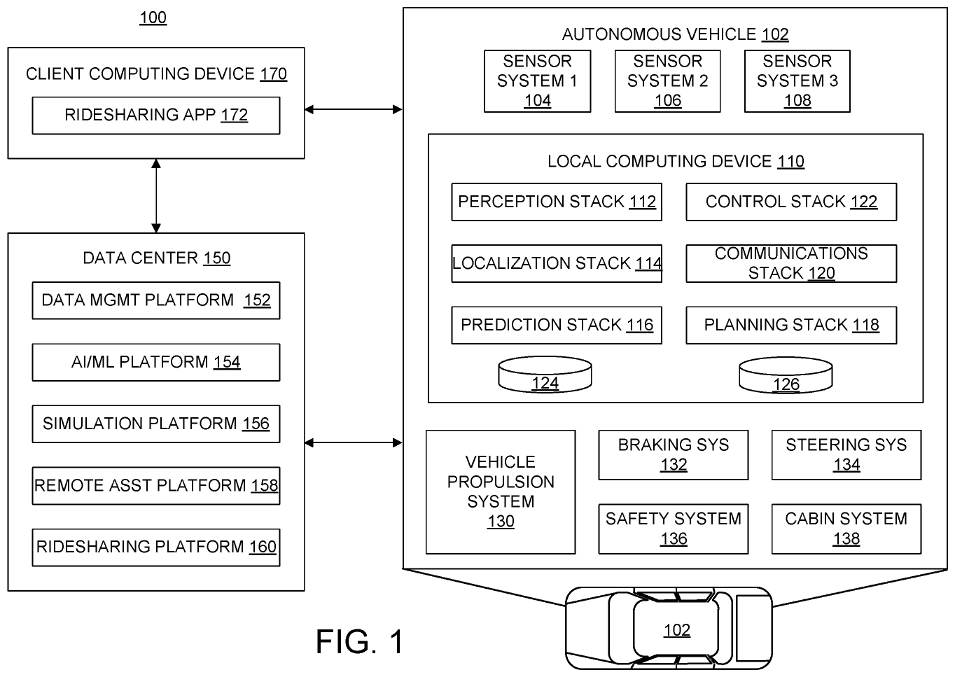

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, Radio Frequency (RF) transceivers, antennas, antenna arrays, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and a High Definition (HD) geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematics of the object (information about its movement), a tracked path of the object, and a description of the pose of the object (its orientation or heading, etc.). In some cases, the bounding area may be defined on a grid that consists of a rectangular, cylindrical, or spherical projection of the camera data and/or LIDAR data.

The mapping and localization stack 114 can determine the AV's position and orientation (pose) using different methods from multiple systems (e.g., GPS, IMUs, cameras, LIDAR, RADAR, ultrasonic sensors, the HD geospatial database 122, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point. In some embodiments, the prediction stack 116 can output a probability distribution of likely paths or positions that the object is predicted to take.

The planning stack 118 can determine how to maneuver or operate the AV 102 safely and efficiently in its environment. For example, the planning stack 116 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WIFI network connection, a mobile or cellular network connection (e.g., Third Generation (3G), Fourth

Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the cartography platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the cartography platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the cartography platform 162; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

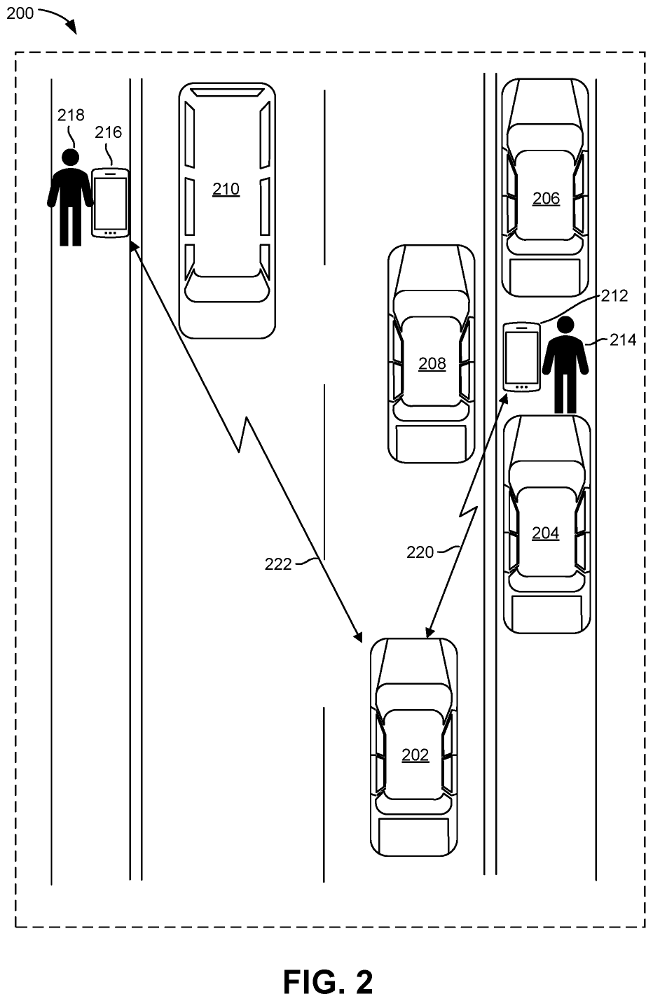

FIG. 2 illustrates an example environment 200 that includes autonomous vehicle (AV) 202. As illustrated, environment 200 may include a two-lane road having a designated parking lane on either side of the road. In some embodiments, environment 200 may include vehicle 204 and vehicle 206 that are properly parked within the parking lane adjacent to the traffic lane used by AV 202. In some cases, environment 200 can include vehicle 208 that is illegally double-parked within the traffic lane and is obstructing the path of AV 202. In some examples, environment 200 may include vehicle 210 that is travelling towards AV 202 in the oncoming traffic lane.

In some embodiments, environment 200 may include one or more pedestrians such as pedestrian 214 and pedestrian 218. In some cases, pedestrian 214 can be associated with wireless device 212 and pedestrian 218 can be associated with wireless device 216. In some examples, pedestrian 214 may be partially obscured from AV 202 by vehicle 204 and/or vehicle 208. In some aspects, pedestrian 218 may be partially obscured from AV 202 by vehicle 210. In some cases, occlusions and/or obstructions (e.g., as described above with regard to pedestrian 214 and pedestrian 218) may cause occlusions in data obtained by sensor system 104-108. For example, visual signals from a camera sensor may be occluded. As another example, LIDAR signals from a LIDAR sensor may be occluded.

In some cases, the sensor systems 104-108 of AV 202 can include one or more radio frequency (RF) transceivers that can be used to perform RF sensing. In some aspects, RF sensing can be used to detect presence and location of wireless devices (e.g., wireless device 212 and/or wireless device 216). In some examples, AV 202 can detect the presence of wireless devices (e.g., wireless device 212 and/or wireless device 216) to help detect or locate users (e.g., pedestrian 214 and/or pedestrian 218) that may be entirely or partially occluded within environment 200.

In some aspects, the RF transceivers can be configured to detect, receive, and/or transmit one or more RF signals. For example, an RF transceiver on AV 202 may be configured to receive RF signal 220 from wireless device 212 and/or RF signal 222 from wireless device 216. In some cases, an RF transceiver may receive RF signal 220 and/or RF signal 222 using one or more antennas. For instance, RF signal 220 and/or RF signal 222 can be received using one or more omnidirectional antennas, one or more directional antennas, one or more phased scanned array antennas, one or more mixed type antennas, any other suitable antenna configuration, and/or any combination thereof.

In some embodiments, AV 202 can send a message (e.g., a ping) that can be used to prompt a wireless device to transmit one or more RF signals (e.g., for detecting and/or locating a wireless device). In some aspects, the message can include a cellular communication (e.g., Global System for Mobile communication (GSM), General Packet Radio Service (GPRS), Enhanced Data Rates for GSM Evolution (EDGE), Universal Mobile Telecommunications Service (UMTS), High Speed Packet Access (HSPA), Code-Division Multiple Access (CDMA), Evolution-Data Optimized (EV-DO, EVDO, or 1xEV-DO), Short Message Service (SMS), or Wi-MAX). In some instances, the message can be transmitted by AV 202 to a cell phone tower or base station (not illustrated), and the base station may then transmit the message to wireless devices 212 and/or wireless 216. In some cases, the message may be initiated via wireless communication with one or more cellphone operators.

In some cases, AV 202 may send a ping to wireless device 212 that causes wireless device 212 to transmit RF signal 220. In another example, AV 202 may send a ping to wireless device 216 that causes wireless device 216 to transmit RF signal 222. In some cases, AV 202 may broadcast a ping that can cause all wireless devices within range of AV 202 to transmit one or more RF signals. In some examples, AV 202 may initiate the message using one or more cellular protocols, which may cause one or more nearby cell phones towers to generate a ping that can be received by multiple wireless devices. In some aspects, the ping may have a range corresponding to the range of downlink signals transmitted by the cell phone tower. In some configurations, the signal strength of the ping may be adjusted based on the location of a wireless device (e.g., wireless device 212 and/or wireless device 216). In some examples, the signal strength of the ping can be adjusted to minimize pings from wireless devices that are farther away from AV 202. In some cases, the signal strength of the message transmission can be calculated by using the electromagnetic signal attenuation characteristics which may vary based on an environment (e.g., urban, rural, etc.).

In some examples, AV 202 may transmit a ping after detecting an abnormal or dangerous situation. For example, AV 202 may detect an abnormal situation based on vehicle 208 being illegally double-parked. In some cases, the perception stack 112 of AV 202 may determine that a ‘blind spot’ is created based on the configuration of vehicle 208 and vehicle 204. In some aspects, AV 202 may use RF sensing to detect the presence of pedestrian 214 and/or to increase a confidence level associated with a prediction associated with pedestrian 214.

In some cases, AV 202 may filter RF signals (e.g., RF signal 220, RF signal 222, and/or any other RF signals) to produce filtered RF signals. In some aspects, filtering techniques can be used to reduce spatial variations. In some instances, filtering techniques can be used to reduce temporal variations. In some examples, filtering techniques can be performed to process (e.g., average) signals received by different antennas or antenna elements. In some embodiments, filtering techniques can be used to reduce or eliminate noise (e.g., caused by RF signal reflections). In some examples, the RF signals can be filtered based on a particular time or a particular window of time (e.g., a timestamp, a time snapshot, and/or multiple time snapshots).

In some cases, AV 202 can process RF signal 220 to determine a location of wireless device 212. For example, AV 202 can process RF signal 220 to calculate a direction (e.g., angle of arrival) and/or a distance of wireless device 212 relative to AV 202. In some cases, AV 202 can process RF signal 222 to determine a location of wireless device 216. For example, AV 202 can process RF signal 222 to calculate a direction and/or distance of wireless device 216 relative to AV 202. Although a single RF signal is illustrated between AV 202 and each of the respective wireless devices (e.g., wireless device 212 and wireless device 216) in FIG. 2, those skilled in the art will recognize that RF sensing can include transmitting and/or receiving numerous RF signals that can be used to determine direction and/or distance.

In some embodiments, AV 202 can use the RF signals (e.g., RF signal 220 and/or RF signal 222) to determine a direction, distance, and/or location probability map corresponding to the wireless devices in environment 200 (e.g., wireless device 212 and/or wireless device 216). In some aspects, AV 202 can determine a direction distribution map based on RF sensing data obtained using a phase-scanned antenna array. In some cases, AV 202 can determine direction, distance, and/or location distribution maps using a cell-phone emission analytical model. In some aspects, AV 202 can determine direction, distance, and/or location distribution maps using a cell-phone emission simulation model. In some examples, direction, distance, and/or location distribution can be based on a delta modulation (e.g., deterministic).

In some aspects, AV 202 can determine a location probability map based on the direction and/or distance probability maps. For example, RF sensing data can be used to determine a distance and angle between AV 202 and wireless device 212 and/or between AV 202 and wireless device 216. In some cases, the location probability map can include an uncertainty metric associated with the predicted location.

In some cases, AV 202 can determine a potential occupancy map that can identify potential locations for a wireless device. In some examples, the potential occupancy map can be based on high-definition (HD) map data (e.g., stored in HD geospatial database 126) of environment 200 (e.g., streets, trees, foliage, pavement, buildings, etc.). For instance, the AV 202 can use HD map data to determine the location of a building and AV 202 can eliminate the building as a potential location for a wireless device in the potential occupancy map. In some examples, the potential occupancy map can be based on perceptions (e.g., sensor systems 104-108), predictions, and/or tracking data.

In some examples, AV 202 can combine the potential occupancy map (e.g., based on HD map data) and the location probability map (e.g., based on RF sensing data) to generate a composite probability map. In some cases, the composite probability map can include an overlay of the location probability map on the potential occupancy map. In some embodiments, the composite probability map, the potential occupancy map, the location probability map, the RF sensing data, and/or any other data can be provided to the perception stack 112, the prediction stack 116, and/or the planning stack 118 of AV 202.

In some aspects, the composite probability map can be used by the perception stack 112 to focus perception resources to high probability occupancy areas. For example, perception resources (e.g., sensor systems 104-108) can be focused on the area in front of vehicle 204 based on high probability of occupancy in that area by wireless device 212. In some examples, perception resources can be focused on the opposite sidewalk based on a high probability of occupancy in that area by wireless device 216.

In some embodiments, the composite probability map can be used by the prediction stack 116 to adjust detected object classes. For example, AV 202 can use the composite probability map to identify pedestrian 214 and/or pedestrian 218. In some cases, the prediction stack 116 can use the composite probability map to adjust predictions associated with pedestrian 214 and/or pedestrian 218. For example, AV 202 can determine that pedestrian 214 is walking around to the driver side door of vehicle 208. In some aspects, the planning stack 118 can adjust a path for maneuvering AV 202 based on the composite probability map.

In some cases, AV 202 may not determine or predict a location, a range and/or a direction for a wireless device. In one illustrative example, an omni-directional antenna may receive an RF signal and AV 202 may not be able to infer direction information based on the reception. In some aspects, AV 202 may make prediction decisions in the absence of location, range, and/or direction data. For instance, AV 202 may spawn ghost tracks that may be used to consider the possibility of having a pedestrian in an occluded area (e.g., considered by prediction stack 116 and/or planning stack 118). In some cases, a probability map may not be generated when there is no spatial information to represent with the probability map.

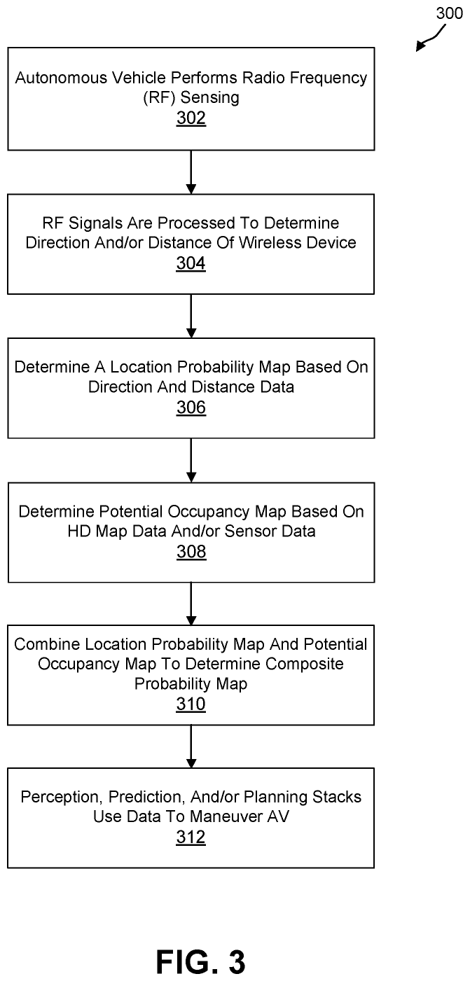

FIG. 3 illustrates an example method 300 for performing radio frequency sensing by an autonomous vehicle. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

In some embodiments, at block 302 the method 300 includes performing radio frequency (RF) sensing by an autonomous vehicle. For example, AV 202 can perform RF sensing. In some cases, RF sensing can include receiving and/or transmitting RF signals to one or more wireless devices. For instance, AV 202 can receive RF signals (e.g., RF signal 220) from wireless device 212. In some cases, RF sensing can include transmitting a signal (e.g., ping) that can cause a wireless device to transmit one or more RF signals. In some examples, an AV may perform RF sensing based on the detection and/or presence of occluded areas that are within range of the AV. In some examples, the AV can determine or predict (e.g., via prediction stack 114) that an occluded area poses a risk to the safe operation of the AV. For example, AV 202 may perform RF sensing (e.g., transmit a signal) upon identifying occluding vehicle 204 and/or vehicle 208 on the side of the road.

In some aspects, at block 304 the method 300 includes processing RF signals to determine direction and/or distance of a wireless device relative to the AV. For example, AV 202 can process RF signal 220 and/or RF signal 222 to determine the direction and/or distance of wireless device 212 and/or wireless device 216. In some cases, processing the RF signals can include implementing filtering techniques to eliminate noise, reduce spatial and temporal variations, perform averaging, etc.

In some cases, at block 306 the method 300 includes determining a location probability map based on the direction and distance data. In some aspects, the location probability map can include potential locations for the detected wireless devices. For instance, AV 202 can determine a location probability map that includes probable locations for wireless device 212 and/or wireless device 216. In some examples, a location probability map can be represented as a set of coordinates of objects (points, lines). In some aspects, a location probability map can include a cartesian grid, a cylindrical grid, a spherical grid and/or a non-uniform grid. In some cases, each cell within a grid can contain information relating to the presence or absence of objects. For example, each cell within a location probability map can contain one or more probability values associated with presence of an object and/or a set of object classes.

In some examples, at block 308 the method 300 includes determining a potential occupancy map based on high-definition (HD) map data and/or sensor data. For instance, AV 202 can use HD map data of the environment 200 to identify potentially relevant locations for a wireless device. In some cases, the potential occupancy map can be used to eliminate potential locations that are not relevant to the AV. For example, wireless devices that are located on the second floor of a building may be disregarded by the AV. In some cases, the potential occupancy map can be generated by performing point-wise multiplication of the probability map with a second probability map that is associated with the HD map. In some aspects, the second probability map may be generated by assigning a probability value to one or more HD map cells that can be based on objects and/or materials in the HD map. For example, a tree trunk in the HD map can have corresponding cells that are assigned a probability value of 0 (e.g., not possible for wireless device to be collocated with the tree). In some cases, the association of the objects of within the HD map and the probability of occupancy (e.g., probability values) may be made by training a machine learning model using historical occupancy and HD map data.

In some embodiments, at block 310 the method 300 includes combining the location probability map and the potential occupancy map to determine a composite probability map. In some aspects, the composite probability map may be calculated by multiplying the location probability map by the potential probability map (e.g., using point-wise multiplication in spatial dimensions). In some cases, the composite probability map includes the potential locations of wireless devices superimposed on an HD map of the environment. For instance, the potential location of wireless device 216 can be associated with the sidewalk on the opposite side of the street to AV 202. In another example, the potential location of wireless device 212 can be associated with the parking lane that is adjacent to the traffic lane occupied by AV 202.

In some aspects, at block 312 the method 300 includes providing the data (e.g., composite probability map, location probability map, potential occupancy map, RF sensing data, etc.) to the perception stack, the prediction stack, and/or the planning stack. In some cases, the perception stack, the prediction stack, and/or the planning stack can use the data to maneuver the AV. For example, the perception stack 116 can use the composite probability map to focus AV resources (e.g., sensors) to areas associated with areas associated with a threshold occupancy probability (e.g., likely to include a wireless device). In another example, the prediction stack 116 can use the composite probability map to adjust detected object classes (e.g., pedestrian, bicycle, animal, etc.).

In some cases, the AV can use RF sensing data to determine an activity type associated with the wireless device. Examples of activity types may include a telephone call, video call, streaming media (e.g., audio or video streaming), web surfing, etc. In some examples, the AV may use the activity type associated with a wireless device to adjust a prediction of a detected object behavior. For example, the AV may increase the probability that a pedestrian will illegally cross the street if the activity type indicates that the pedestrian is distracted (e.g., video streaming).

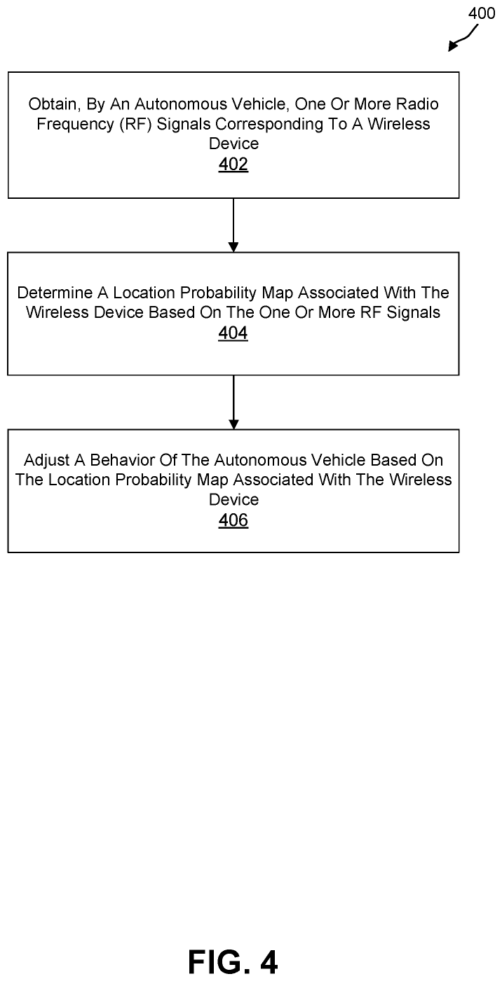

FIG. 4 illustrates an example method 400 for performing radio frequency sensing by an autonomous vehicle. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

In some embodiments, at block 402 the method 400 includes obtaining, by an autonomous vehicle, one or more radio frequency (RF) signals corresponding to a wireless device. For example, AV 202 can obtain (e.g., receive) RF signal 220 corresponding to wireless device 212. In some aspects, the method 400 can include sending a ping to the wireless device, wherein the one or more RF signals are obtained in response to the ping. For instance, AV 202 can send a ping to wireless device 212. In some cases, the ping can cause wireless device 212 to transmit RF signal 220. In some examples, one or more RF signals can be received using one or more electromagnetic antennas that are receptive to the electromagnetic frequency range used by wireless devices. In some cases, the antennas can include ultra-wideband (UWB) antennas that can be configured to receive signals within the UWB frequency range (e.g., 3.1 GHz to 10.6 GHz).

In some aspects, at block 404 the method 400 can include determining a location probability map associated with the wireless device based on the one or more RF signals. For example, AV 202 can determine a location probability map that is associated with wireless device 212 based on RF signal 220. In some embodiments, determining the location probability map associated with the wireless device can include determining a plurality of probabilistic locations for the wireless device, wherein the plurality of probabilistic locations is based on the one or more RF signals. For example, AV 202 can determine a plurality of probabilistic locations for wireless device 212 and/or wireless device 216. For example, RF signal 220 can be used to determine a distance and/or a direction of wireless device 212 relative to AV 202. In some aspects, the plurality of probabilistic locations for wireless device 212 and/or wireless device 216 can be based on RF signal 220 and RF signal 222, respectively. In some aspects, the probabilistic locations may be determined by calculating a probability using RF sensing data associated with one or more receiving antennas and multiplying the probability distributions point-wise. In some examples, the location can be determined from the probability distribution by calculating a weighted average of one or more possible locations and selecting the location that is associated with a maximum probability. In some cases, the location can be selected based on a maximum probability that is averaged over a spatial window. In some examples, the spatial window may have a size ranging from 1 centi-meter to 10 meters.

In some cases, the method 400 can include directing one or more sensors of the autonomous vehicle to at least a portion of the plurality of probabilistic locations for the wireless device. For example, AV 202 may direct one or more sensors (e.g., sensor systems 104-108) to the area between vehicle 204 and vehicle 206.

In some instances, at block 406 the method 400 can include adjusting a behavior of the autonomous vehicle based on the location probability map associated with the wireless device. For example, AV 202 may adjust a parameter relating to trajectory, route, speed, etc. based on the location probability map associated with the wireless device 212 and/or its associated user pedestrian 214.

In some examples, the method 400 can include determining a location of the wireless device based on the location probability map. For example, AV 202 can determine a location of wireless device 212 based on the location probability map. In some cases, the location may correspond to a single location in the location probability map. In some aspects, the location may correspond to a location having the higher probability metric in the location probability map.

In some embodiments, the method 400 can include determining, based on map data of a geographic environment of the autonomous vehicle, a potential occupancy map that includes a plurality of potential locations for the wireless device. For example, AV 202 can determine a potential occupancy map of environment 200 that includes a plurality of potential locations for wireless device 212 and/or wireless device 216. In some cases, the location of the wireless device can be further based on the potential occupancy map and the location probability map.

In some aspects, the method 400 can include determining a type of activity associated with the wireless device based on the one or more RF signals. For example, AV 202 can determine that wireless device 212 is being used for navigation, video streaming, web surfing, etc. In some examples, the method 400 can include adjusting, by a prediction stack of the autonomous vehicle, a predicted position of an object associated with the wireless device based on the type of activity. For instance, AV 202 may adjust a prediction for pedestrian 214 based on the activity type associated with wireless device 212.

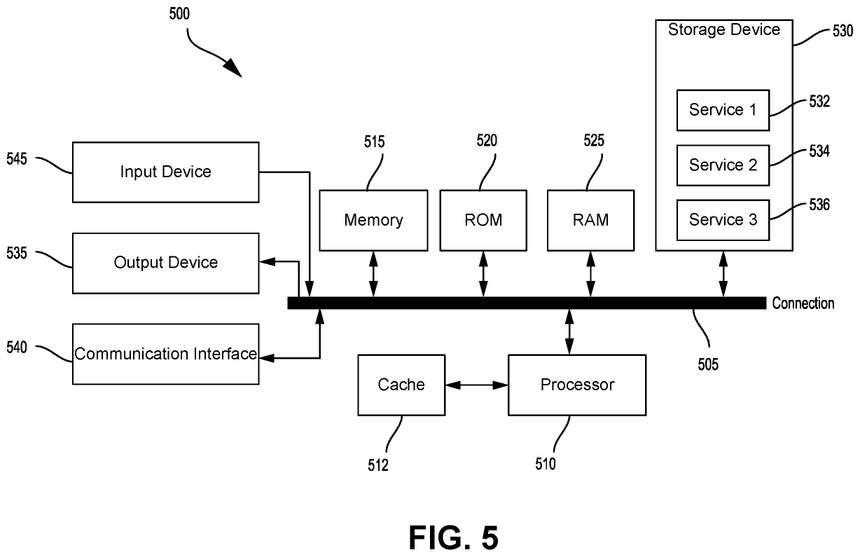

FIG. 5 shows an example of computing system 500, which can be for example any computing device making up autonomous vehicle 102 or remote computing system 150, or any component of autonomous vehicle 102 or remote computing system 150 in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random access memory (RAM) 525 to processor 510. Computing system 500 can include a cache of high-speed memory 512 connected directly with, in close proximity to, or integrated as part of processor 510.

Processor 510 can include any general purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. There is no restriction on operating on any particular hardware arrangement, and therefore the basic features here may easily be substituted for improved hardware or firmware arrangements as they are developed.

Storage device 530 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Some examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” a set indicates that one member of the set or multiple members of the set satisfy the claim. For example, claim language reciting “at least one of A and B” means A, B, or A and B.

What is claimed is:

1. A method comprising:
obtaining, by an autonomous vehicle, one or more radio frequency (RF) signals corresponding to a wireless device;
determining a location probability map associated with the wireless device based on the one or more RF signals; and
adjusting a behavior of the autonomous vehicle based on the location probability map associated with the wireless device.

2. The method of claim 1, further comprising:
determining a location of the wireless device based on the location probability map.

3. The method of claim 1, further comprising:
sending a ping to the wireless device, wherein the one or more RF signals are obtained in response to the ping.

4. The method of claim 1, wherein determining the location probability map includes determining a plurality of probabilistic locations for the wireless device.

5. The method of claim 4, further comprising:
directing one or more sensors of the autonomous vehicle to at least a portion of the plurality of probabilistic locations for the wireless device.

6. The method of claim 1, further comprising:
determining, based on map data of a geographic environment of the autonomous vehicle, a potential occupancy map that includes a plurality of potential locations for the wireless device, wherein a location of the wireless device is based on the potential occupancy map and the location probability map.

7. The method of claim 1, further comprising:
determining a type of activity associated with the wireless device based on the one or more RF signals.

8. The method of claim 7, further comprising:
adjusting, by a prediction stack of the autonomous vehicle, a predicted position of an object associated with the wireless device based on the type of activity.

9. An autonomous vehicle (AV) comprising:
at least one memory; and
at least one processor coupled to the at least one memory, wherein the at least one processor is configured to:
obtain one or more radio frequency (RF) signals corresponding to a wireless device;
determine a location probability map associated with the wireless device based on the one or more RF signals; and
adjust a behavior of the AV based on the location probability map associated with the wireless device.

10. The AV of claim 9, wherein the at least one processor is further configured to:
determine a location of the wireless device based on the location probability map.

11. The AV of claim 9, wherein the at least one processor is further configured to:
send a ping to the wireless device, wherein the one or more RF signals are obtained in response to the ping.

12. The AV of claim 9, wherein determining the location probability map includes determining a plurality of probabilistic locations for the wireless device.

13. The AV of claim 12, further comprising one or more sensors, wherein the at least one processor is further configured to:
direct the one or more sensors to at least a portion of the plurality of probabilistic locations for the wireless device.

14. The AV of claim 9, wherein the at least one processor is further configured to:
determine, based on map data of a geographic environment of the autonomous vehicle, a potential occupancy map that includes a plurality of potential locations for the wireless device, wherein a location of the wireless device is based on the potential occupancy map and the location probability map.

15. A non-transitory computer-readable storage medium having stored thereon instructions which, when executed by one or more processors, cause the one or more processors to:
obtain, by an autonomous vehicle, one or more radio frequency (RF) signals corresponding to a wireless device;
determine a location probability map associated with the wireless device based on the one or more RF signals; and
adjust a behavior of the autonomous vehicle based on the location probability map associated with the wireless device.

16. The non-transitory computer-readable storage medium of claim 15, comprising additional instructions which, when executed by one or more processors, cause the one or more processors to:
determine a location of the wireless device based on the location probability map.

17. The non-transitory computer-readable storage medium of claim 15, comprising additional instructions which, when executed by one or more processors, cause the one or more processors to:
send a ping to the wireless device, wherein the one or more RF signals are obtained in response to the ping.

18. The non-transitory computer-readable storage medium of claim 15, wherein determining the location probability map includes determining a plurality of probabilistic locations for the wireless device.

19. The non-transitory computer-readable storage medium of claim 18, comprising additional instructions which, when executed by one or more processors, cause the one or more processors to:
direct one or more sensors of the autonomous vehicle to at least a portion of the plurality of probabilistic locations for the wireless device.

20. The non-transitory computer-readable storage medium of claim 15, comprising additional instructions which, when executed by one or more processors, cause the one or more processors to:
determine a type of activity associated with the wireless device based on the one or more RF signals; and
adjust, by a prediction stack of the autonomous vehicle, a predicted position of an object associated with the wireless device based on the type of activity.
